(19) United States
(12) Patent Application Publication
(10) Pub. No.: US 2024/0044712 A1
(43) Pub. Date: Feb. 8, 2024

(54) POLARIMETRY

(71) Applicant: Oxford University Innovation Limited, Oxford (Oxfordshire) (GB)

(72) Inventors: Chao HE, Oxford (Oxfordshire) (GB); Martin BOOTH, Oxford (Oxfordshire) (GB)

(21) Appl. No.: 18/268,701

(22) PCT Filed: Dec. 14, 2021
(86) PCT No.: PCT/GB2021/053293

§ 371 Date: Jun. 21, 2023

(30) Foreign Application Priority Data
Dec. 22, 2020 (GB) 2020334.5

(51) Int. Cl. G01J 4/04

(52) U.S. Cl. CPC G01J 4/04

(57) ABSTRACT

A polarimeter (10) is disclosed. The polarimeter (10) comprises: a full Poincaré generator (110) configured to receive an incident light beam with unknown polarisation state and generate a full Poincaré beam therefrom; a polariser (130) configured to select an eigenstate from the full Poincaré beam generated by the full Poincaré generator (110); a detector (170) configured to detect a spatial distribution of intensity of the eigenstate selected by the polariser; and a processor (250) configured to determine a polarisation state of the incident light beam in dependence on the output from the detector (170).

### TECHNICAL FIELD

The present invention relates to a method and apparatus for polarimetry and polarisation imaging.

### BACKGROUND

Polarisation sensing is vital in many areas of research, with applications spanning from microscopy to aerospace technology. The improvement of measurement precision and system sensitivity always has wide importance. Traditional approaches for polarimetry may be cumbersome.

Polarisation sensing methods can be divided into two categories: time-resolved, where measurements are taken using a sequence of analysers in a time multiplexed manner, or snapshot, where different analysers are spatially multiplexed. Time resolved measurements can be easier to implement, but snapshot methods are crucial for applications with rapidly changing inputs. The standard approaches in both methods are directly or indirectly related to a core measurement equation: S=inv(A)·I, where S is the Stokes vector to be measured, and I is the vector of intensities recorded at the detector. Matrix A is known as the instrument matrix, which is determined by the system configuration. In order to enhance precision and sensitivity, numerous attempts have been made to push A towards an optimal matrix as it determines the properties of the error propagation and hence affects the measurement precision. An evaluation of systematic error amplification can be performed using the condition number (CN) of A. The theoretical minimum value CN=\sqrt{3} for polarisation sensing has been widely studied and utilised both theoretically and experimentally.

Improvements in polarisation sensing are desirable.

### SUMMARY

According to a first aspect, there is provided a polarimeter, comprising:
a full Poincaré generator configured to receive an incident light beam with unknown polarisation state and generate a full Poincaré beam therefrom;
a polariser configured to select an eigenstate from the full Poincaré beam generated by the full Poincaré generator;
a detector configured to detect a spatial distribution of intensity of the eigenstate selected by the polariser; and
a processor configured to determine a polarisation state of the incident light beam in dependence on the output from the detector.

The full Poincaré generator may comprise a graded refractive index, GRIN, lens.

The detector may comprise an array of detector elements configured to measure the transverse distribution of intensity of a beam from the polariser. For example the array of detector elements may be a camera that determines an image (comprising a 2D array of pixels at which intensity is sampled).

The processor may be configured to determine one or more positions of maximum intensity in the transverse distribution of intensity.

The processor may be configured to implement a machine learning algorithm that has been trained to estimate the one or more positions of maximum intensity.

The machine learning algorithm may comprise a convolutional neural network.

There may be more than one position of maximum intensity, and the processor may be configured to refine the estimate of the positions of maximum intensity based on a centrosymmetric constraint.

The processor may be configured to determine a polarisation state of the incident light from the one or more positions of maximum intensity.

Determining the polarisation state from the one or more positions of maximum intensity may comprise using a predetermined lookup table (or equivalent) that relates the position of the one or more positions of maximum intensity with a state of polarisation of the input beam.

The processor may be configured to determine an amount of depolarisation from a level of contrast in the spatial distribution of intensity determined by the detector.

According to a second aspect, there is provided a polarisation imager, comprising:
an array of full Poincaré generators configured to sample incident light with unknown polarisation state at a plurality of different transverse positions and generate an array of full Poincaré beams therefrom;
a polariser configured to select an eigenstate from each full Poincaré beam in the array of full Poincaré beams generated by the array of full Poincaré generators;
a detector configured to detect a spatial distribution of intensity of each eigenstate selected by the polariser; and
a processor configured to determine a polarisation state of the incident light beam at each of the sampled transverse positions in dependence on the output from the detector.

Each full Poincaré generator may comprise a graded refractive index lens.

The detector may comprise an array of detector elements configured to measure the transverse distribution of intensity of a beam from the polariser.

The processor may be configured to determine one or more positions of maximum intensity in each eigenstate from the measured transverse distribution of intensity.

The processor may be configured to implement a machine learning algorithm that has been trained to determine the one or more positions of maximum intensity in each eigenstate.

The machine learning algorithm may comprise a convolutional neural network.

There may be more than one position of maximum intensity in each eigenstate, and the processor may be configured to refine the estimate of the positions of maximum intensity based on a centrosymmetric constraint.

The processor may be configured to determine a polarisation state of the incident light at each of the plurality of different transverse positions from the one or more positions of maximum intensity in each eigenstate.

Determining the polarisation state from the one or more positions of maximum intensity may comprise using a predetermined lookup table that relates the position of the one or more positions of maximum intensity in each eigenstate with a state of polarisation.

The processor may be configured to determine an amount of depolarisation from a level of contrast in the spatial distribution of intensity determined by the detector.

According to a third aspect, there is provided a method of determining a polarisation state of a light beam, comprising:
generating a Poincaré beam from the incident light beam;
using a polariser to select an eigenstate from the full Poincaré beam generated by the full Poincaré generator;

a detector configured to determine a spatial distribution of intensity of the eigenstate selected by the polariser; and
a processor configured to determine a polarisation state of the incident light beam in dependence on the output from the detector.

According to a fourth aspect, there is provided a method of performing polarisation imaging, comprising:
using an array of full Poincaré generators to sample incident light with unknown polarisation state at a plurality of different transverse positions and generate an array of full Poincaré beams therefrom;

selecting an eigenstate from each full Poincaré beam in the array of full Poincaré beams generated by the array of full Poincaré generators;
detecting a spatial distribution of intensity of each eigenstate selected by the polariser; and
determining a polarisation state of the incident light beam at each of the sampled transverse positions using the output from the detector.

Each full Poincaré generator may comprise a graded refractive index lens.

Determining a polarisation state of the incident light beam at each of the sampled transverse positions may comprise using a processor to determine one or more positions of maximum intensity in the or each eigenstate from the measured transverse distribution of intensity.

The processor may be configured to implement a machine learning algorithm that has been trained to determine the one or more positions of maximum intensity in the or each eigenstate.

The features of each aspect (including optional features) may be combined with those of any other aspect. For example, features described with reference to the first and second aspects may be used in the methods according to the third or fourth aspects.

### BRIEF DESCRIPTION OF THE DRAWINGS

Example embodiments will be described, by way of example only, with reference to the drawings, in which:

FIG. 1 shows a block diagram of a polarimeter according to an embodiment;

FIG. 2 is a schematic of a polarisation imager according to an embodiment;

FIG. 3 shows an example of a full Poincaré generator comprising an array of linear retarders;

FIG. 4 shows an example of a full Poincaré generator comprising an array of diattenuators;

FIG. 5 shows that a full Poincaré generator with different order numbers, may comprise a graded refractive index lens;

FIG. 6 illustrates how the state of polarisation of an incident light field can be mapped onto a spatial distribution of light intensity;

FIG. 7 illustrates how a state of polarisation can be determined from the spatial distribution of light intensity (shown in FIG. 6);

FIG. 8 is a block diagram of a processing pipeline for determining the input state of polarisation from an intensity distribution employing a convolutional neural network;

FIG. 9 is a graph showing the relationship between pixel number and theoretical systematic sensitivity;

FIG. 10 illustrates a test setup in which a polarisation state generator provides light to a polarisation state analyser;

FIG. 11 shows a set of sampled points from a Poincaré sphere, showing experimental data compared with ground truth (obtained theoretically);

FIG. 12 shows graphs of error obtained from a randomly selected subset of the sampled points of FIG. 11;

FIG. 13 shows a distribution of polarisation states arising from a linear vertically polarised incident light field perpendicular to a spatially variant half-wave plate array;

FIG. 14 shows the impact of misalignment between the incident light field and the spatially variant half-wave plate array;

FIG. 15 compares results obtained according to an embodiment with prior art results, for the case shown in FIG. 14; and

FIG. 16 illustrates that a degree of polarisation can be determined from contrast in an intensity distribution, according to embodiments.

### DETAILED DESCRIPTION

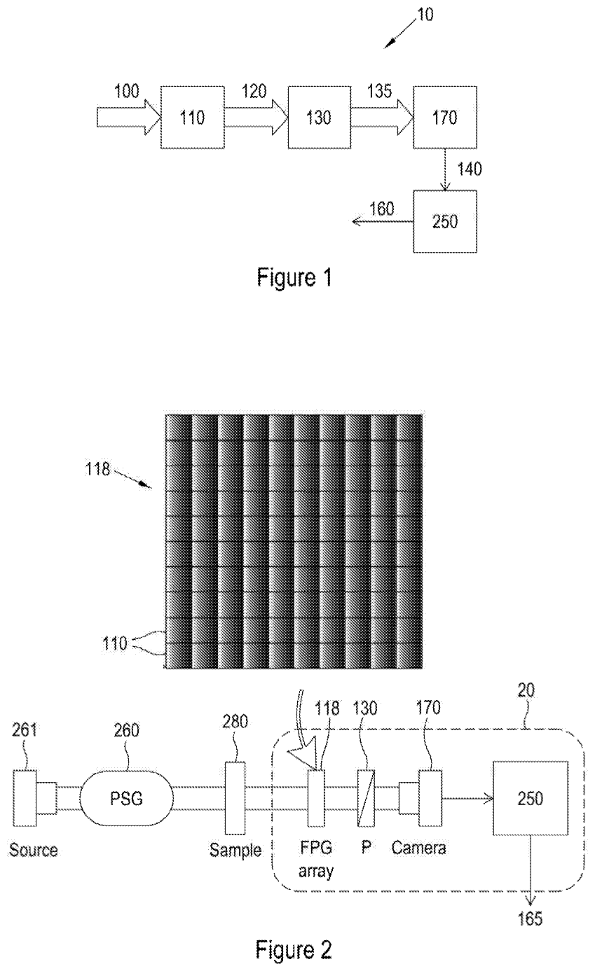

Referring to FIG. 1, a block diagram of a polarimeter 10 according to an embodiment is shown, comprising: full Poincaré generator 110, polariser 130, detector 170 and processor 250.

The polarimeter 10 receives an incident light beam 100 with an unknown state of polarisation (SOP). The full Poincaré generator (FPG) 110, according to the definition used herein, will produce a full Poincaré beam from any uniform input polarisation state, so the output of the FPG 110 is a full Poincaré beam (FPB) 120, which will include all polarisation states. As described in WO2020/120943, a GRIN lens can be used as a FPG 110, but other types of FPG may also be used. The specific distribution of polarisation states in the full Poincaré beam 120 (from a particular FPG) will depend on the polarisation state of the incident light beam 100.

The polariser 130 selects a polarisation state from the full Poincaré beam 120, which may be termed an eigenstate of the full Poincaré beam. Since the distribution of polarisation states in the full Poincaré beam 120 depends on the polarisation state of the incident light beam 100, this effectively maps the spatial variation in polarisation state in the full Poincaré beam 120 to a spatial variation in intensity in the beam 135 following the polariser 130.

The detector 170 is configured to detect and output the spatial distribution of intensity 140 in the beam 135 after the polariser 130. This spatial distribution of intensity 140 encodes the input polarisation state of the incident light beam 100.

The processor 250 receives the spatial distribution of intensity 140 from the detector 170 and determines the polarisation state of the input beam 100 therefrom. Examples of how this can be achieved will be explained more fully below.

FIG. 2 shows a polarisation imager 20 according to an embodiment, comprising: FPG 20 array 118, polariser 130, detector 170 and processor 250.

The polarisation imager 20 works on similar principles to the polarimeter 10, except there is an array 118 of FPGs 110 (in this example, a 2D array). The detector 170 is configured to detect a distribution of intensity of an eigenstate from each FPG 110 (selected by the polariser 130). One way to do this is to use superpixels comprising a 2D sub-array of pixels, so that each superpixel determines a polarisation state for a FPG in the array corresponding to a different spatial location in the image. The example embodiment is shown with a light source 261 illuminating a sample 280 in transmission mode via a polarisation state generator 260 (e.g. as shown hereinbelow), but this is not essential.

There are two types of existing systems that can generate a full Poincaré beam (FPB). The first type has the functionality of transferring a specific SOP (or a limited range of SOPs) into an FPB. A typical system configuration is based on two liquid crystal spatial light modulators (SLMs) or a system using multiple passes from a single SLM. Under such a geometry, due to the SLM having a uniformly distributed slow/fast axis orientation, it is strongly polarisation dependent. It can be used to generate an FPB but is not a FPG according to the definition used herein, since it cannot generate an FPB from an arbitrary incident SOP. For example, if the incident SOP is linear and aligned in the same direction as the fast axis orientation of the first SLM, then the modulation of such a pass would lose all functionality. Hence with only one degree of freedom introduced by the second SLM (or the second pass) an arbitrary SOP cannot be generated.

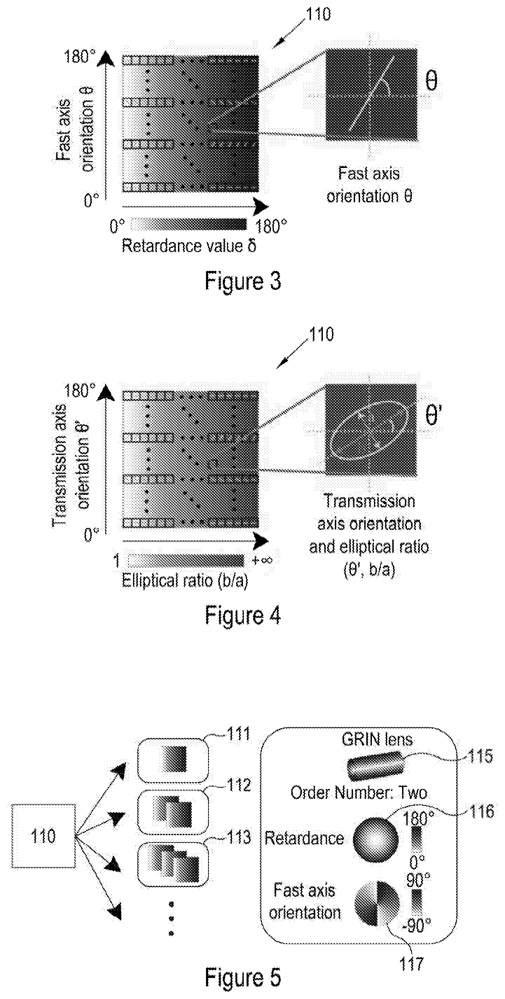

A FPG according to the definition used herein may comprise a linear retarder assembly that contains all combinations of fast axis orientations (θ from 0° to 180°) and retardance values (δ from 0° to 180°) as shown in FIG. 3. An example of this type of FPG is a graded refractive index lens.

An alternative type of FPG comprises a mixed diattenuator array as shown in FIG. 4, comprising all eigenvector possibilities (defined by transmission axis orientation θ′ ranging from 0° to 180° and eigenvector elliptical ratio b/a from 1 to +∞).

FPGs herein are not limited to these two broad types but could also in principle be generated by other mechanisms.

FIG. 5 illustrates that an FPG 110 with order greater than 1 is possible (such as order 2, 112, and order 3, 113). A FPG with order 2 generates an output beam comprising two regions that each comprise the full Poincaré sphere of SOPs. As illustrated in FIG. 5, a GRIN lens 115 can be used as an FPG with order 2, due to the GRIN lens comprising two full variations in fast axis orientation 117.

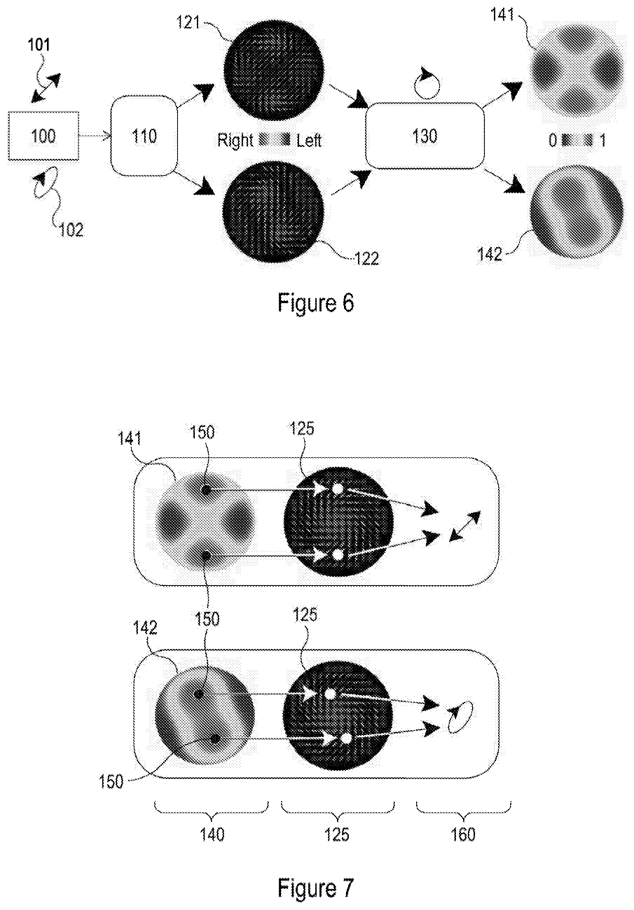

FIG. 6 shows conceptually how polarimetry according to embodiments works. An incident light field 100 is shown with two different SOPs: a linear 45° polarisation 101 and an elliptical polarisation 102. The incident light field 100 is converted by a FPG 110 (e.g. a GRIN lens) into FPBs 121, 122. The FPBs 121, 122 have different distributions of polarisation state. A polariser 130 (e.g. a right hand circular polariser) selects an eigenstate from the FPBs 121, 122, which results in a distribution of intensity 141, 142 that depends on the SOP of the incident light 100.

In some embodiments an image processing algorithm may be used to directly relate a detected intensity distribution 141, 142 to a SOP of the incident light 100.

FIG. 7 depicts one method for determining a SOP from the intensity distribution 140 of the selected eigenstate, comprising identifying at least one position of maximum intensity in the intensity distribution 140 selected by the polariser 130. The intensity distributions 141, 142 obtained from the initial SOPs 101, 102 from FIG. 6 are shown as inputs to this process.

For an FPB with order 2 (such as a GRIN lens, used in this example), there will be two positions of maximum intensity 150. For an FPB with order 1 there would be a single position of maximum intensity (and so on). Where there is more than one position of maximum intensity in the intensity distribution 140, in principle a single position is enough to determine the SOP of the input, but determining more than one position of maximum intensity 150 may be used to reduce error (which may otherwise result from noise and other measurement uncertainties).

As schematically illustrated in FIG. 7, a map 125 can be used to determine a corresponding SOP 160 from each position of maximum intensity 150. A graphical illustration of this map 125 is shown, but this may be implemented as a lookup table and/or approximated with a function, such as a piecewise fit (e.g. a lookup table with suitable interpolation). In this case, the determined polarisation is correctly illustrated, based on the mapping 125 shown. The mapping 125 will be defined by the particular FPG 110 and the eigenstate that is selected by the polariser 130.

In certain embodiments, all points of the intensity distribution 140 may be used to determine an accurate location for the at least one point of maximum intensity 150. A range of techniques can be used to determine the position of the point of maximum intensity 150. In a very simple example, the intensity distribution 140 may be smoothed using a moving average, and a maximum value of the intensity distribution 140 determined as the position of the point of maximum intensity 150.

A more robust approach for determining at least one position of maximum intensity 150 is to use an image processing machine learning algorithm. A convolutional neural network (CNN) is a suitable type of machine learning algorithm. The intensity distribution 140 may be provided to a CNN that determines a probability map defining the probability (e.g. from 0-1) that each location comprises a position of maximum intensity 150. The probability map can be used by a further algorithm to determine the at least one position of maximum intensity 150 (for example, in the case of a GRIN lens FPG, based a centrosymmetric constraint).

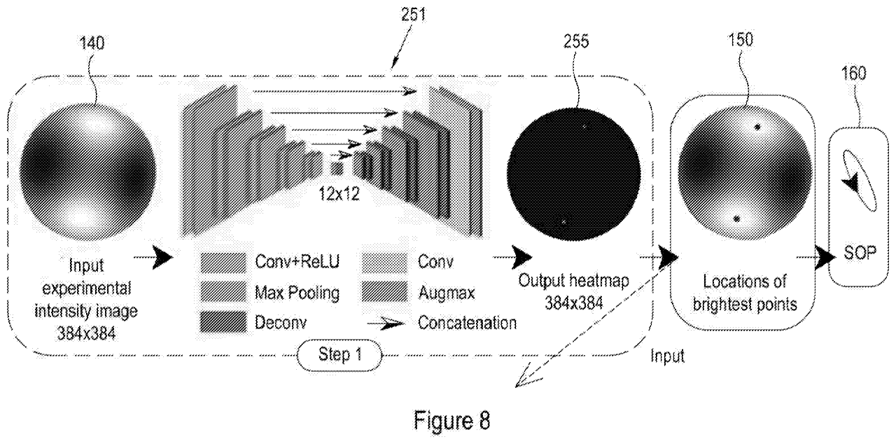

FIG. 8 illustrates this approach with an example. The input intensity distribution 140 (measured by a detector) comprises a 384×384 pixel image (but other resolutions are of course possible). The intensity distribution 140 is input to a CNN 251, which has been trained to identify at least one position of maximum intensity 150 in measurements from the system used to generate the input intensity distribution. The CNN 251 follows an encoder-decoder structure, where the encoder down-samples the input to extract deeper features, and the decoder up-samples the feature map to integrate information from the encoder at different scales. In the specific example shown in FIG. 8 (which should not be construed as limiting, since other hyperparameters can be used), the encoder comprises 5 layers, each of these comprising a convolution layer (e.g. 2DConv) followed by a ReLU (rectified linear unit) layer. The decoder comprises 5 layers each comprising an upsampler and a convolution layer, with the exception of the last layer, in which the final layer comprises a softmax (or argmax) layer, which normalises the probability distribution.

The output probability map 255 (which may also referred to as a heat map) may be further processed to refine the positions of the at least one position of maximum intensity 150 (e.g. by imposing a centrosymmetric constraint). The positions of maximum intensity 150 may be used with a lookup table 125 (or similar) to determine the input SOP therefrom.

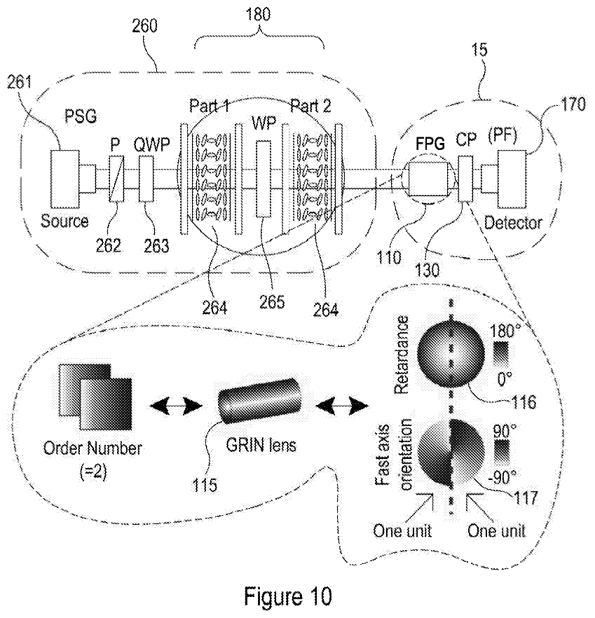

In order to train the example CNN 251, 57877 pairs of simulated/experimental images were used to generate a training set. The simulated images were calculated via a GRIN lens retardance model as ground truth. The experimental images were acquired with known SOP input using the system shown in FIG. 10. The data was generated by uniform sampling on the Poincaré sphere, in order to cover as large a parameter range as possible. The locations of the brightest points were directly found from the simulated images, followed by a Gaussian distribution to indicate the local area around them to model the expected network output heatmap. Then pairs of noisy intensity images and corresponding heatmaps (with a one-to-one correspondence), were used to train the network. To increase the training set size as well as to simulate data conditions in real-world applications, the training data was augmented using contrast and brightness changes.

The example CNN 251 was trained with a stochastic gradient descent (SGD) optimizer using gradients computed with backpropagation, with batch size set to 4, learning rate 0.001, momentum 0.9. A weighted L-2 loss function (Eq. 1)) was adopted to deal with the “imbalanced classification” problem, since the bright area only takes up a small part of the image:

$$Loss = \frac{1}{2 N} {\sum }_{i = 0}^{N - 1} {{w}_{i} ( {v}_{i} - {v}_{i}^{*} )}^{2} + λ {‖ A ‖}^{2} , \qquad ( 1 )$$

where N is the total number of pixels, vᵢ the predicted value of the i th pixel, and vᵢ* the ground truth value of the i th pixel. wᵢ is the weight of the i th pixel, which was set to 50 if vᵢ*>0, otherwise 1. λ=0.0005 is the coefficient of the regulariser A, where A=[a₀, a₁, a₂, . . . , aₖ] is the set of all parameters in the network. The network was trained over 5 epochs and converged in one hour on a PC (OS: Ubuntu 16.04; CPU: i7-4770; GPU: NVIDA GTX 1080 Ti).

There are several advantages of using machine learning to identify positions of maximum intensity in the intensity distribution: i) preparation of the training set is straightforward and it is easy to cover an adequate domain; ii) finding the SOP takes only 30 ms on a normal desktop GPU, enabling real-time online SOP detection; iii) the network is robust to temporal/spatial noise from the image acquisition system.

According to the example approach in which a probability map 255 of the position(s) of maximum intensity is determined, there is an intrinsic link between the image resolution (with pixel number n×n) and the polarisation resolution (sensitivity Sₚ) of the system.

This hardware parameter could be used to indicate the maximum sensitivity of the system (defined as the minimum SOP change that can be detected), assuming other noise sources are minimised, which can guide the training process of the CNN with respect to the best effective dataset. This sensitivity can be calculated as

$${S}_{p} = K \cdot \sqrt[{D}_{s}]{\frac{η}{R} ,} \qquad ( 2 )$$

where Dₛ is the dimension of the Stokes vector,

$$R = \frac{π \cdot {n}^{2}}{4}$$

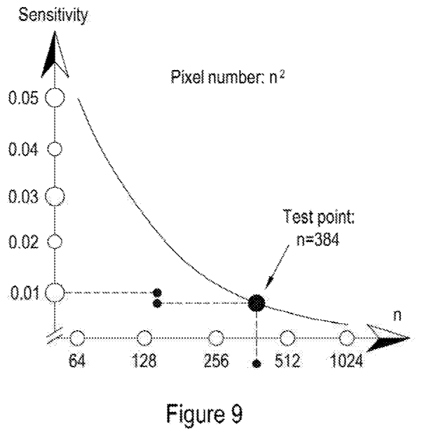

represents the effective pixel number (for a GRIN lens based FPG, there is a circular area). K is a constant parameter. As the topological order η of the GRIN lens is 2, there would in effect be half the number of pixels to determine Sₚ. Here it is assumed the sampling depth is sufficient and the non-linearity of the system is low. Following the above equation, it is possible to plot the theoretical relationship between Sₚ and intensity image with resolution n×n, if systematic and random errors are minimised, as shown in FIG. 9. For a detector comprising 383×384 pixels, the sensitivity is slightly less than 0.01. For a Sₚ can be boosted using a higher camera pixel resolution.

In other embodiments, rather than the CNN determining a probability map 255 that is useful for determining at least one position of maximum intensity 150, a CNN may be trained to simply determine the input SOP directly from the input intensity distribution 140. This may be a less flexible approach, in that the CNN will encode the mapping 125 of the intensity distribution 140 of the selected eigenstate to input SOP (so the CNN will be tailored for a specific PBG 110 and polariser 130), but may be more accurate.

FIG. 10 shows a polarisation state generator (PSG) 160 used in training the example embodiment. The PSG 160 is capable of generating an arbitrary SOP, and comprises a light source 261, polariser 262, quarter wave plate 263, spatial light modulator (SLM) 264 and waveplate 265. The light source 261 may comprise an LED (e.g. 3 W, 633 nm, Δλ=20 nm). The polariser 262 (e.g. Thorlabs, LPVIS050) generates linear polarised light at 45° with respect to the slow (modulating) axis orientation of the SLM 264. A double-path using reflection was adopted using a single SLM 264, in order to generate an arbitrary SOP. The waveplate 265 is a quarter waveplate, transited twice, to act as a half-wave plate. The SLM 264 and waveplate 265 therefore together form a spatially variant half-wave plate 180. The polarisation state of the output from the PSG can be selected based on the encoding applied by the SLM 264.

A polarisation state analyser (PSA) 15, receives light with an arbitrary SOP from the PSG 260 and detects an intensity distribution 140 suitable for processing to determine the input SOP in accordance with embodiments,. The PSA 15 comprises an FPG 110 in the form of a GRIN lens (e.g. Femto Technology Co. Ltd., G-B161157-S1484, NA=0.1, Pitch=2) followed by a fixed circular polariser 130 (e.g. Thorlabs, CP1L633) and detector (e.g. Thorlabs, DCC3240N). FIG. 10 also shows the link between an FPG with order number two and GRIN lens 115. In the GRIN lens 115, the retardance 116 is arranged with circular symmetry, rather than the conceptual Cartesian arrangement shown in FIGS. 3 and 4.

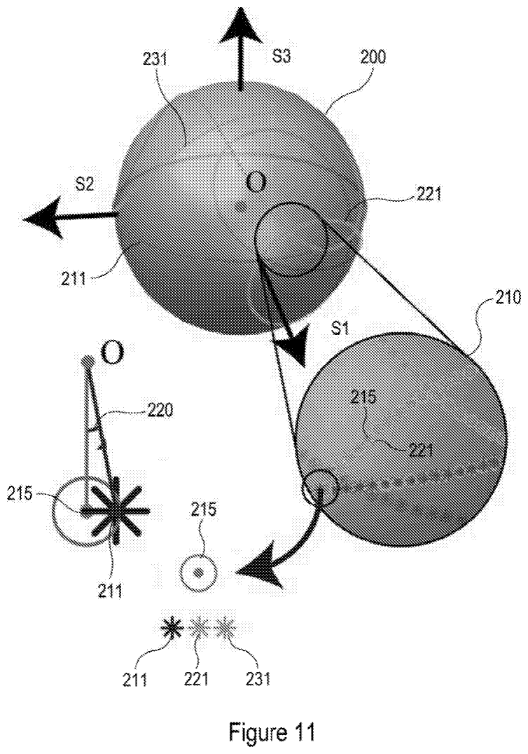

FIG. 11 demonstrates the feasibility of the approach described herein. Three randomly selected curves are shown on a Poincaré sphere 200. Nine hundred SOPs from these curves were generated using a polarisation state generator (PSG) and their polarisation determined using the example embodiment described above. Theoretical data points 215 and experimental data points 211, 221, 231 from each curve are shown on the Poincaré sphere 200, along with an illustration of an example error 220 for one of the points. The mean error ΔΨ across the 900 sampled points was ±0.18° (very low).

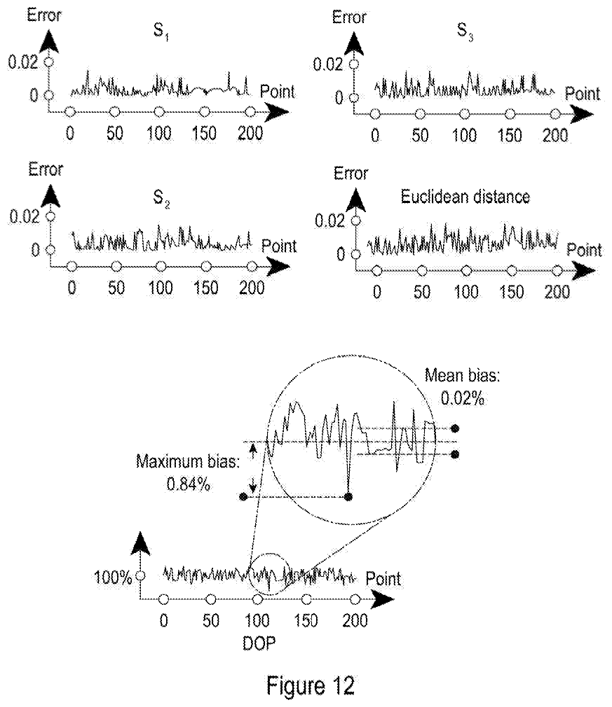

FIG. 12 shows S₁, S₂, S₃, and Euclidean distance errors from 200 randomly sampled points (from the 900 SOPs on the three curves shown in FIG. 11). Exceptional measurement precision is achieved across the whole Poincaré sphere with stable performance.

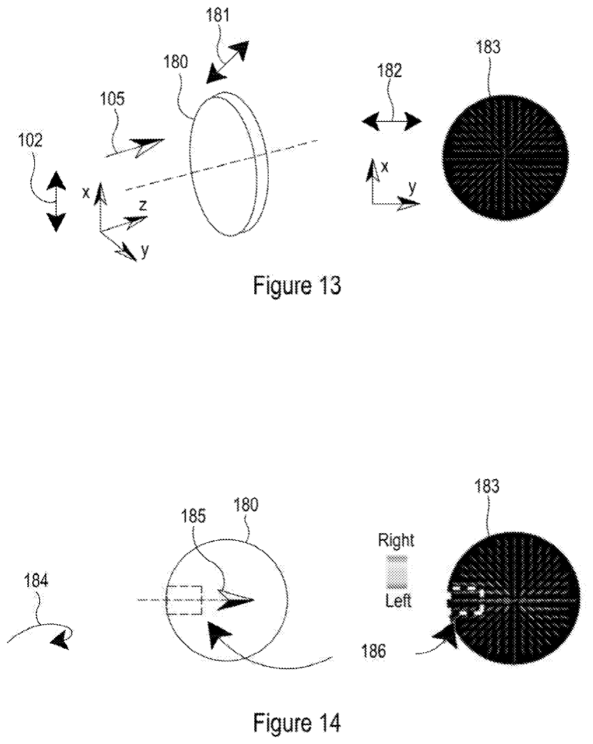

FIGS. 13 to 15 illustrate an example application of a polarimeter according to embodiments. A spatially variant half-wave plate array may be used to generate a vectorial beam or depletion beam in the context of stimulated emission depletion (STED) microscopy. In these applications, a small polarisation error can be catastrophic. FIG. 13 shows a linear vertically polarised incident light field 105 perpendicular to the spatially variant half-wave plate array 180, positioned with its overall position axis 181 oriented at 45°. The resulting output 183 from the array 180 should have linear horizontal polarisation 182 along the y axis. FIG. 14 illustrates a tilt 184 of the array 180 by 3° around the x axis, which results in deviations from the linear horizontal SOP in the output spatial distribution of polarisation states 183 along the y axis.

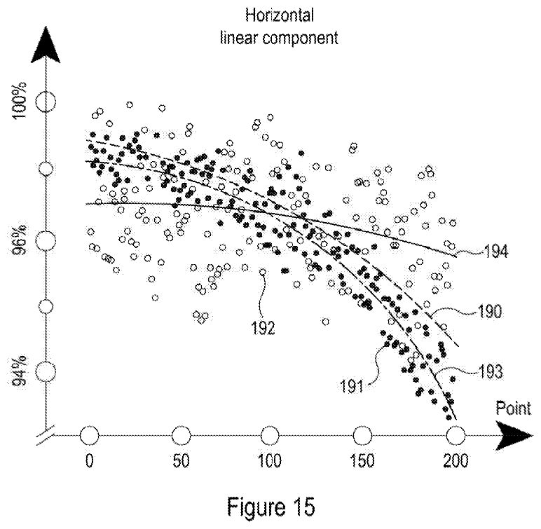

The SOPs in the output 183 was analysed according to the example embodiment described herein, sampling along 200 points on the arrow 185 (along the y axis) in the sample region 186. The results are depicted in FIG. 15, which compares results obtained according to an embodiment 191 and from a prior art point Stokes polarimeter 192. Best fit lines 193, 194 are provided for the measurements from an embodiment and according to the prior art respectively. These can be compared with a ground truth (theoretical) curve 190. It is clear that measurement of SOP according to embodiments is more accurate and more sensitive than prior art approaches, as expected. A more detailed statistical analysis has been performed by the inventors which further supports this conclusion.

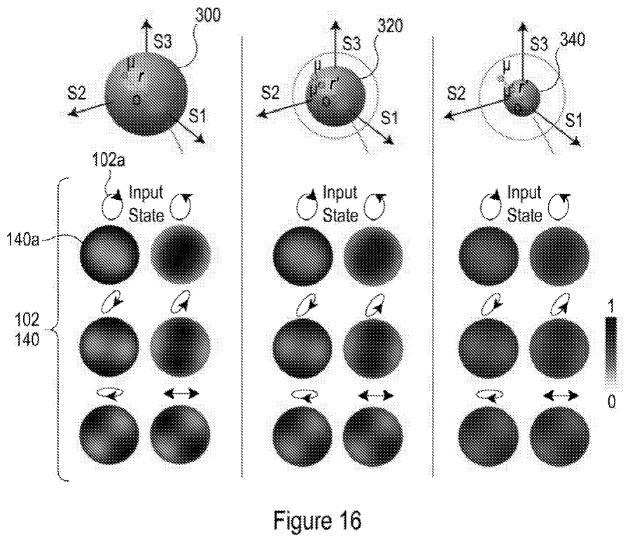

FIG. 16 illustrates measurement of depolarisation in accordance with embodiments. Depolarisation is an important parameter in numerous techniques and applications. This parameter can also be additionally extracted via the intensity distribution 140 of the eigenstate selected by the polariser 130 in the FPG polarimeter 10. FIG. 16 shows the typical intensity distributions 140 of several random input SOPs 102 selected from the Poincaré sphere 300, 320, 340 with different levels of depolarisation (0% 20% and 60% respectively)/Input SOP 102a results in intensity distribution 140a, and so on.

The SOP of the polarised parts of the input light field corresponding with each Poincaré sphere remains the same. The level of contrast in the intensity distribution 140 image is proportional to the level of depolarisation of the target beam. The DOP (degree of polarisation, which is the inverse of the degree of depolarisation) of the input light field can be therefore be calculated from a normalised intensity value of the brightest and darkest points (Iₘₐₓ and Iₘᵢₙ) on the intensity distribution 140 according to a simple calculation, DOP=(Iₘₐₓ−Iₘᵢₙ)/(Iₘₐₓ+Iₘᵢₙ) This is another advantage of polarimeters according to embodiments, which may enable the depolarisation to be determined in a simple way.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub combination.

The examples provided in the detailed description are intended to provide examples of the invention, not to limit its scope, which should be determined with reference to the accompanying claims.

1. A polarimeter, comprising:
a full Poincaré generator configured to receive an incident light beam with unknown polarisation state and generate a full Poincaré beam therefrom;
a polariser configured to select an eigenstate from the full Poincaré beam generated by the full Poincaré generator;
a detector configured to detect a spatial distribution of intensity of the eigenstate selected by the polariser; and
a processor configured to determine a polarisation state of the incident light beam in dependence on the output from the detector.

2. The polarimeter of claim 1, wherein the full Poincaré generator comprises a graded refractive index, GRIN, lens.

3. The polarimeter of claim 2, wherein the detector comprises an array of detector elements configured to measure the transverse distribution of intensity of a beam from the polariser.

4. The polarimeter of claim 3, wherein the processor is configured to determine one or more positions of maximum intensity in the transverse distribution of intensity.

5. The polarimeter of claim 4, wherein the processor is configured to implement a machine learning algorithm that has been trained to determine the one or more positions of maximum intensity.

6. The polarimeter of claim 5, wherein the machine learning algorithm comprises a convolutional neural network.

7. The polarimeter of any of claims 4 to 6, wherein there is more than one position of maximum intensity, and the processor is configured to refine the estimate of the positions of maximum intensity based on a centrosymmetric constraint.

8. The polarimeter of any of claims 4 to 7, wherein the processor is configured to determine a polarisation state of the incident light from the one or more positions of maximum intensity.

9. The polarimeter of claim 8, wherein determining the polarisation state from the one or more positions of maximum intensity comprises using a predetermined lookup table that relates the position of the one or more positions of maximum intensity with a state of polarisation of the input beam.

10. The polarimeter of any preceding claim, wherein the processor is configured to determine an amount of depolarisation from a level of contrast in the spatial distribution of intensity determined by the detector.

11. A polarisation imager, comprising:
an array of full Poincaré generators configured to sample incident light with unknown polarisation state at a plurality of different transverse positions and generate an array of full Poincaré beams therefrom;
a polariser configured to select an eigenstate from each full Poincaré beam in the array of full Poincaré beams generated by the array of full Poincaré generators;
a detector configured to detect a spatial distribution of intensity of each eigenstate selected by the polariser; and
a processor configured to determine a polarisation state of the incident light beam at each of the sampled transverse positions in dependence on the output from the detector.

12. The polarisation imager of claim 11, wherein each full Poincaré generator comprises a graded refractive index lens.

13. The polarisation imager of claim 12, wherein the detector comprises an array of detector elements configured to measure the transverse distribution of intensity of a beam from the polariser.

14. The polarisation imager of claim 13, wherein the processor is configured to determine one or more positions of maximum intensity in each eigenstate from the measured transverse distribution of intensity.

15. The polarisation imager of claim 14, wherein the processor is configured to implement a machine learning algorithm that has been trained to determine the one or more positions of maximum intensity in each eigenstate.

16. The polarisation imager of claim 15, wherein the machine learning algorithm comprises a convolutional neural network.

17. The polarisation imager of any of claims 14 to 16, wherein there is more than one position of maximum intensity in each eigenstate, and the processor is configured to refine the estimate of the positions of maximum intensity based on a centrosymmetric constraint.

18. The polarisation imager of any of claims 14 to 17, wherein the processor is configured to determine a polarisation state of the incident light at each of the plurality of different transverse positions from the one or more positions of maximum intensity in each eigenstate.

19. The polarisation imager of claim 18, wherein determining the polarisation state from the one or more positions of maximum intensity comprises using a predetermined lookup table that relates the position of the one or more positions of maximum intensity in each eigenstate with a state of polarisation.

20. The polarisation imager of any of claims 11 to 19, wherein the processor is configured to determine an amount of depolarisation from a level of contrast in the spatial distribution of intensity determined by the detector.

21. A method of determining a polarisation state of a light beam, comprising:
generating a Poincaré beam from the incident light beam;
using a polariser to select an eigenstate from the full Poincaré beam generated by the full Poincaré generator;
a detector configured to determine a spatial distribution of intensity of the eigenstate selected by the polariser; and
a processor configured to determine a polarisation state of the incident light beam in dependence on the output from the detector.

22. A method of performing polarisation imaging, comprising:
using an array of full Poincaré generators to sample incident light with unknown polarisation state at a plurality of different transverse positions and generate an array of full Poincaré beams therefrom;
selecting an eigenstate from each full Poincaré beam in the array of full Poincaré beams generated by the array of full Poincaré generators;
detecting a spatial distribution of intensity of each eigenstate selected by the polariser; and
determining a polarisation state of the incident light beam at each of the sampled transverse positions using the output from the detector.

23. The method of claim 21 or claim 22, wherein each full Poincaré generator comprises a graded refractive index lens.

24. The method of claim 22 or 23, wherein determining a polarisation state of the incident light beam at each of the sampled transverse positions comprises using a processor to determine one or more positions of maximum intensity in the or each eigenstate from the measured transverse distribution of intensity.

25. The polarisation imager of claim 24, wherein the processor is configured to implement a machine learning algorithm that has been trained to determine the one or more positions of maximum intensity in the or each eigenstate.
